(19) United States
(12) Patent Application Publication
(10) Pub. No.: US 2025/0111189 A1
(43) Pub. Date: Apr. 3, 2025

(54) INTERTWINED-GNN: A GRAPH NEURAL NETWORK FOR LEARNING EMBEDDINGS ON HETEROGENEOUS GRAPHS

(71) Applicant: Oracle International Corporation, Redwood Shores, CA (US)

(72) Inventors: Jonas Schweizer, Schlieren (CH); Damien Hilloulin, Zurich (CH); Marouane Maatouk, Casablanca, MA (US); Benedikt Schesch, Zurich (CH)

(21) Appl. No.: 18/375,073

(22) Filed: Sep. 29, 2023

(51) Int. Cl. G06N 3/04

(52) U.S. Cl. CPC G06N 3/04

(57) ABSTRACT

In an embodiment, a computer hosts and operates an input neural layer of an artificial neural network that generates, based on all of the features of a first vertex of a first vertex type in a graph, an embedding of the first vertex. The embedding of the first vertex has a predefined size that does not depend on the first vertex type. The input neural layer generates, based on all of the features of a first edge of a first edge type in the graph, an embedding of the first edge. A subsequent neural layer of the artificial neural network generates an embedding of a second vertex of a second vertex type in the graph, and this generating is based on: the embedding of the first vertex and all of the features of the second vertex, including a particular feature that is not a feature of the first vertex type.

### FIELD OF THE INVENTION

The present invention relates to graph embedding. Herein is an artificial neural network architecture based on a schema of a logical graph.

### BACKGROUND

A heterogeneous graph is a logical graph that contains vertices (i.e. nodes) of multiple vertex types or edges of multiple edge types. Features (i.e. data fields) associated with each vertex type or edge type can have a different datatype, semantic meaning, and dimensionality. The different types of edges and nodes tend to capture different information and give important information about the structure of the graph. A typical graph neural network (GNN) is designed for homogeneous graphs and thus is unable to operate on heterogeneous graphs. Some GNN approaches disregard edge features thus missing critical information.

As an example in a heterogeneous graph in the banking domain, financial “transaction” edges could record the amount, date, and the status of a transaction which may be relevant information for fraud detection. Likewise, “contract” edges might represent contractual obligations between persons. All of the different types of edges could be important to improve the accuracy of a machine learning model to detect whether a transaction seems fraudulent or not.

Some approaches have a preprocessor that applies some transformations on a heterogeneous graph to transform it into a homogeneous graph that can be analyzed. One possible transformation is to make all nodes become of a same universal (i.e. homogeneous) node type and the features of the universal node type are the union of all possible features of all original node types. If a node type does not have a feature, the feature and its value are imputed during preprocessing or imputed in a learned way during inferencing. Although imputation entails adding synthetic data, this addition is effectively lossy by making it harder to distinguish a contextual role of a node in the heterogeneous topology of the graph, and this loss is counterintuitive and decreases embedding fidelity (i.e. accuracy).

For good reason, state of the art GNN may by design entirely avoid generating embeddings of edges. That is because edges may outnumber vertices in a graph by one or two orders of magnitude, and the disproportionate numerosity of edges may cause dilution of information and dilution of training gradients in which vertices unfortunately mostly or entirely lack influence on the generation of embeddings that represent vertices.

### BRIEF DESCRIPTION OF THE DRAWINGS

In the drawings:

FIG. 1 is a block diagram that depicts an example computer that infers embeddings of graph elements of a graph using an intertwined artificial neural network whose architecture reflects an express or implied schema of the graph;

FIG. 2 is a block diagram that depicts an example computer in which an example intertwined neural dataflow occurs for an example graph and target vertex;

FIG. 3 is a block diagram that depicts an example computer in which type-specific matrices provide learned weights and learned biases for data-driven embedding;

FIG. 4 is a flow diagram that depicts an example computer process to infer embeddings of graph elements of a graph using an intertwined artificial neural network whose architecture reflects an express or implied schema of a graph;

FIG. 5 is a block diagram that illustrates a computer system upon which an embodiment of the invention may be implemented;

FIG. 6 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is graph embedding using an intertwined artificial neural network architecture based on an express or implied schema of a logical graph. This approach has a novel graph neural network (GNN) that works on heterogeneous graphs, including the most common types of graphs. Heterogeneous graphs are graphs in which nodes (i.e. vertices) and edges can have different application-specific types such as customer-product interactions in retail or patient-symptoms-treatment interactions in the medical field. Vertices and edges may have different counts and datatypes of features, which conventional GNNs cannot directly process without preprocessing that may decrease accuracy as discussed in the Background above. The approach herein debuts an intertwined neural network that has a novel architecture that fully supports heterogeneous graphs and can counteract the detrimental effects of large amounts of sampled edges as discussed in the Background.

An intertwined neural network herein accepts, as inputs, heterogeneous graphs, and the heterogeneous structure of the graph is respected during neural operation. This works in a novel manner for both vertex and edge embeddings simultaneously. Each neural layer aggregates, for vertices and edges, both neighboring vertices and their involved edges.

Not entirely unlike skip connections that remind a neural network of its past state, neural intertwining herein has neural connections between vertex embeddings and edge embeddings. These intertwined neural connections feed-forward neighboring vertex embeddings to enrich target vertex embeddings. Because all vertex embeddings herein have the same size, the enriched target vertex embeddings have highly concentrated information, and that information is contextually sensitive to nearby vertex types and edge types and their feature data.

This approach produces the most fidelity and most expressive embeddings which lead to higher classification accuracy on heterogeneous graphs, such as binary classification or scoring regression for learned anomaly detection. To achieve this, an intertwined graph neural network herein is composed of a user-defined number of feed-forward neural layers and exactly two intertwined specialized neural branches.

In an embodiment, a computer hosts and operates an input neural layer of an artificial neural network that generates, based on all of the features of a first vertex of a first vertex type in a graph, an embedding of the first vertex. The embedding of the first vertex has a predefined size that does not depend on the first vertex type. The input neural layer generates, based on all of the features of a first edge of a first edge type in the graph, an embedding of the first edge. A subsequent neural layer of the artificial neural network generates an embedding of a second vertex of a second vertex type in the graph, and this generating is based on: the embedding of the first vertex and all of the features of the second vertex, including a particular feature that is not a feature of the first vertex type.

### 1.0 Example Computer

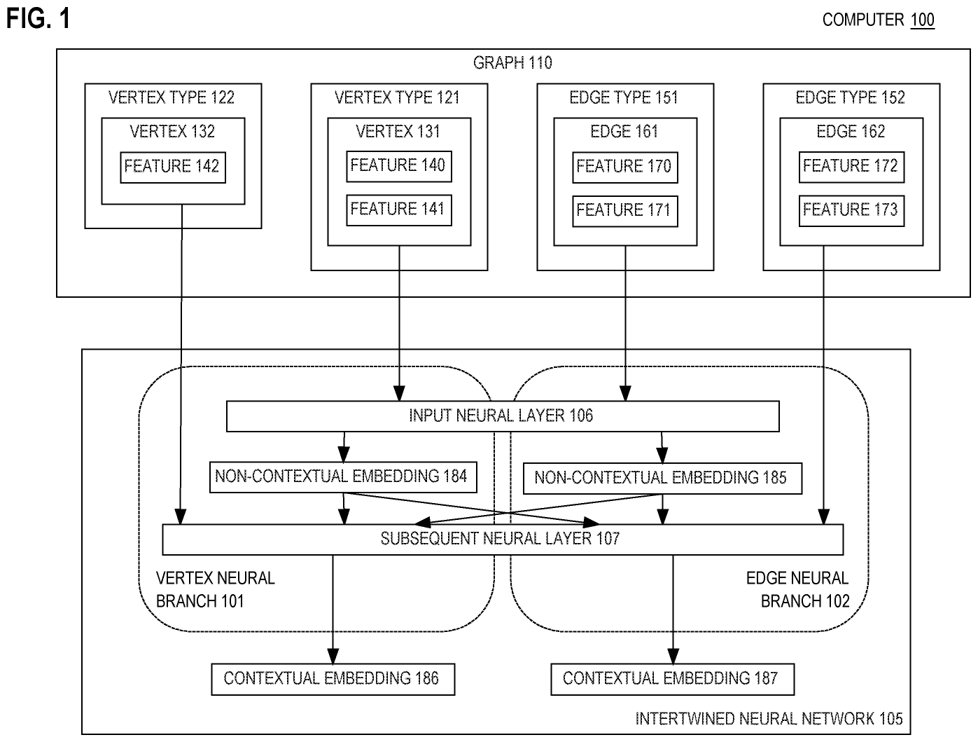

FIG. 1 is a block diagram that depicts an example computer 100. Computer 100 infers embeddings of graph elements 131-132 and 161-162 of graph 110 using intertwined neural network 105 whose architecture reflects an express or implied schema of graph 110. Computer 100 may be one or more of a rack server such as a blade, a personal computer, a mainframe, or a virtual computer.

### 1.1 Graph Elements and their Types

Graph 110 is a logical graph such as a property graph or a flow graph. Graph 110 consists of many graph elements that are many vertices and many edges that interconnect the vertices. For example, graph 110 may contain vertices 131-132 and edges 161-162. Graph 110 may be one of many graphs that conform to an express or implied schema that includes multiple vertex types and multiple edge types, and graph 110 is heterogeneous.

For example, vertices 131-132 are instances of respective vertex types 121-122, and edges 161-162 are instances of respective edge types 151-152. Each vertex type has its own respective set of vertex features that are data fields. Different vertex types may have different respective features and different counts of features, and missing features are not imputed for a vertex type to achieve a universal set of features for all vertex types. For example, vertex type 122 has only one feature 142, and vertex type 121 has two features 140-141. In some examples, two vertex types may have (e.g. partially) overlapping sets of features such that some feature(s) belong to both vertex types.

Each edge type has its own respective set of edge features that are data fields. Different edge types may have different respective features and different counts of features, and missing features are not imputed for an edge type to achieve a universal set of features for all edge types. For example, edge type 151 has two features 170-171, whereas edge type 152 has two features 172-173. In some examples, two edge types may have (e.g. partially) overlapping sets of features such that some feature(s) belong to both edge types.

Although not shown, multiple vertices may have a same vertex type, and multiple edges may have a same edge type. For example, two vertices that both are instances of vertex type 122 may each have a separate (e.g. distinct) value of feature 142. Each feature has a respective (e.g. distinct) datatype such as a text string, a number, a Boolean, or a compound data type such as a multidimensional tensor.

In an embodiment, all vertices are contiguously stored (e.g. in a single vertex array or single database vertex table), and all edges are contiguously stored (e.g. in a single edge array or single database edge table). In an embodiment, vertices or edges of a same type are contiguously stored. In an embodiment, vertices and edges are non-contiguously stored in a fragmented heap.

Each edge connects one or two vertices and, in an embodiment, the edge may contain references to both vertices. Each vertex has zero or more edges and, in an embodiment, the vertex may contain references to edges that are connected to the vertex.

Depending on the embodiment: graph 110 and its edges may be directed or undirected; graph 110 may be connected or disconnected; and graph 110 may be cyclic or acyclic. For example, graph 110 may be a directed acyclic graph (DAG) or an undirected logical tree. Depending on the embodiment, the vertices and edges in graph 110 are stored in volatile or nonvolatile storage of computer 100.

In an embodiment, multiple graph elements may be stored in vertical slices. For example, each feature may be stored as a separate column of multiple values. Graph 110 may be stored in compressed sparse row (CSR) format.

### 1.2 Example Graph Neural Network (Gnn)

Intertwined neural network 105 is an artificial neural network (ANN) that is configured to expect particular types of vertices and edges. For example, an express or implied schema of graph 110 may be decided before intertwined neural network 105 is designed, and intertwined neural network 105 may be generated before graph 110 exists.

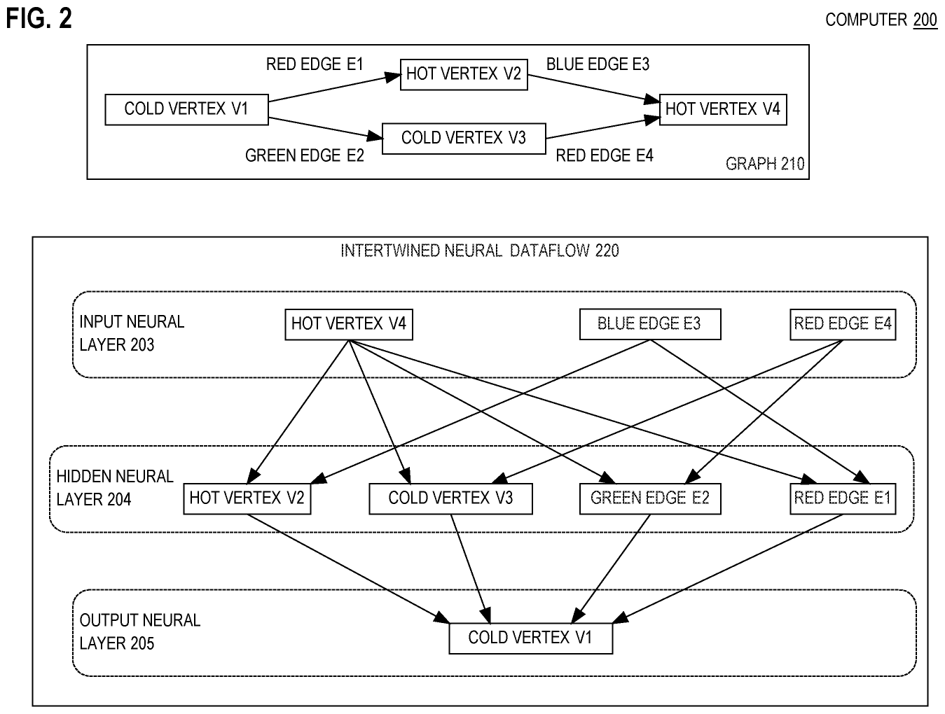

Intertwined neural network 105 is configured to process only some breadth-first traversal subgraphs that may occur according to the schema of graph 110. However, this does not mean that such traversals subgraphs that occur in graph 110 are expressly identified nor extracted. Instead, it means that intertwined neural network 105 ignores any subgraph that occurs in graph 110 if intertwined neural network 105 was not preconfigured to process the subgraph traversal. Later herein is FIG. 2 that presents an example subgraph traversal.

### 1.3 Non-Contextual Embeddings Inferred by Input Neural Layer

Intertwined neural network 105 consists of a sequence of two or more neural layers 106-107. Each neural layer is configured to process a particular portion of a subgraph that conforms to a portion of the schema of graph 110. For example, input neural layer 106 processes only vertices of vertex type 121 and edges of edge type 151 to generate, by learned inference, non-contextual embeddings 184-185. Non-contextual embedding 184 is an embedding of vertex 131, and non-contextual embedding 185 is an embedding of edge 161. Herein, a non-contextual embedding of a graph element contains only a linear encoding, as a numeric array, of all features of the graph element, even if some of the features are non-numeric. Herein, a contextual embedding of a graph element contains an encoding, as a numeric array, of: all features of the graph element and information about neighboring edges and vertices. Distinctions between mechanisms of contextual and non-contextual embeddings are discussed later herein.

Herein, an embedding is an encoded representation of a graph element. Herein regardless of whether an embedding represents an edge or a vertex, and regardless of which type of edge or type of vertex, and regardless of whether an embedding is contextual or non-contextual, all embeddings have one uniform fixed size (e.g. count of bytes or count of numeric array elements). In an embodiment, more or less similar graph elements have more or less similar embeddings. For example, an anomaly detector may train to recognize that an embedding represents an anomalous graph element.

### 1.4 Contextual Embeddings Inferred by Subsequent Neural Layer(s)

Subsequent neural layer 107 processes only: embeddings inferred (i.e. generated) by previous neural layer(s) and vertices of vertex type 122 and edges of edge type 152 to generate, by learned inference, contextual embeddings 186-187 that respectively represent graph elements 132 and 162. Intertwined neural network 105 is shown with a generalized internal architecture. An example specific internal architecture for an example specific graph schema is presented later herein with FIG. 2.

### 1.5 Exactly Two Intertwined and Specialized Neural Branches

Intertwined neural network 105 is a multibranch neural network that contains exactly two neural branches 101-102. Vertex neural branch 101 infers embeddings of vertices, and edge neural branch 102 infers embeddings of edges. Both neural branches 101-102 are used during training and during production use.

Vertex neural branch 101 accepts feature vectors of vertices as input, but not feature vectors of edges. Edge neural branch 102 accepts feature vectors of edges as input, but not feature vectors of vertices.

Each of neural branches 101-102 contains a distinct portion of each of neural layers 106-107. Each of neural layers 106-107 contains a distinct portion of each of neural branches 101-102.

In a state of the art multibranch neural network, each neural branch is operationally independent, and none of the hidden layers in one branch are connected to hidden layers in another branch. Neural branches 101-102 are herein referred to as intertwined, which is a novel architecture in which hidden layers in one neural branch may receive input and send output to the other neural branch. For example as shown, non-contextual embedding 184 or 185 is inferred by one neural branch in input neural layer 106 and then accepted by both neural branches 101-102 in subsequent neural layer 107. Thus, both of vertex embedding 186 and edge embedding 187 are each based on both of vertex embedding 184 and edge embedding 185, which is achieved by the intertwining of neural branches 101-102.

For example, contextual embedding 186 that represents vertex 132 is based on feature 142 and non-contextual embeddings 184-185. Likewise, contextual embedding 187 that represents edge 162 is based on features 172-173 and non-contextual embeddings 184-185.

### 1.6 Separate Invocation of Intertwined Neural Network for Each Target Vertex

As discussed earlier herein, an intertwined neural network may ignore portions of a graph. In an embodiment, a set of one or more target vertices are identified in a graph in an application specific way such as all vertices of a particular vertex type or according to selection criteria based on vertex type and/or vertex features.

In an embodiment, an intertwined neural network is invoked once per target vertex to infer a contextual embedding of the target vertex. For example as shown, intertwined neural network 105 is invoked to infer contextual embedding 186 that represents target vertex 132.

As shown, that one invocation of intertwined neural network 105 causes intertwined neural network 105 to accept (e.g. as feature vectors) graph elements 131-132 and 161-162 as input. Graph 110 may contain many more graph elements and element types than shown. In that case, one invocation of intertwined neural network 105 causes acceptance of only a portion (i.e. graph elements 131-132 and 161-162) of graph 110 as input. As shown, that one invocation of intertwined neural network 105 causes intertwined neural network 105 to infer (i.e. generate) multiple embeddings 184-187, which is a respective embedding of each graph element accepted as input, even if only contextual embedding 186 that represents target vertex 132 is desired. 2.0 EXAMPLE INTERTWINED NEURAL DATAFLOW

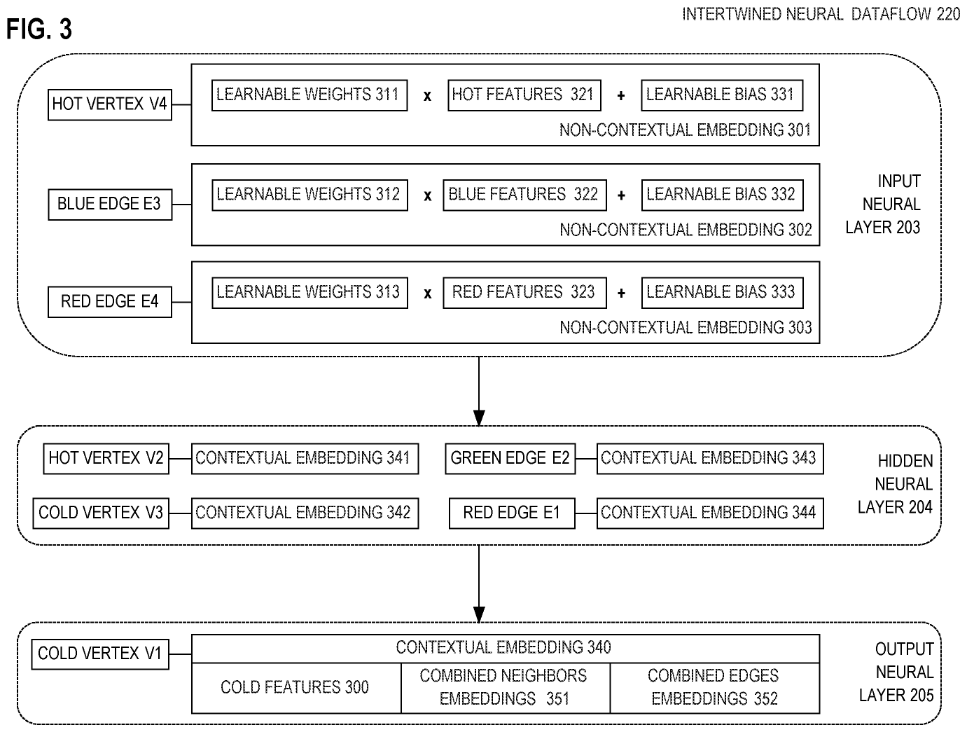

FIGS. 2-3 are block diagrams that depict an example computer 200 that may be an embodiment of computer 100. Computer 200 hosts and operates an intertwined neural network (not shown) that has mechanisms similar to those of intertwined neural network 105 of FIG. 1.

However, the express or implied schemas of graphs 110 and 210 are different, and the neural layers in the respective intertwined neural networks are different. Furthermore, a same express or implied graph schema may be shared by multiple distinct software applications, and each application may have respective intertwined neural networks with different respective sequences of neural layers. For example, two intertwined neural networks may differently process a same graph for same or different target vertex(s).

As discussed earlier herein, an intertwined neural network is invoked for a target vertex to cause acceptance of multiple graph elements as input and to infer (i.e. generate) multiple embeddings, even if only a contextual embedding of the target vertex is desired. Which inputs and their embeddings are involved with an invocation depends on the application specific configuration of the intertwined neural network, which depends on the express or implied graph schema.

This configured acceptance of inputs and generation of embeddings is referred to as a neural dataflow. Neural dataflow depends on all of: application specific configuration of the intertwined neural network, express or implied graph schema, actual graph, and which target vertex.

Intertwined neural dataflow 220 is based on graph 210 and cold vertex V1 as the current target vertex. Graph 210 has a hot vertex type, a cold vertex type, a red edge type, a blue edge type, and a green edge type, and their features are not shown.

Neural activation flows downwards as shown through the sequence of neural layers 203-205 to infer a contextual embedding of target cold vertex V1. For example, an anomaly detector may infer from the contextual embedding of target cold vertex V1 that either graph 210 or target cold vertex V1 is anomalous.

Within intertwined neural dataflow 220 are demonstratively shown graph elements E1-E4 and V1-V4. That does not mean that intertwined neural dataflow 220 actually contains those graph elements. Instead it means that intertwined neural dataflow 220 accepts those graph elements as input (e.g. feature vectors) and infers a respective embedding for each of those graph elements. For example as shown, hidden neural layer 204 generates a contextual embedding of green edge E2 based on: all of the features of green edge E2 and non-contextual embeddings of graph elements E4 and V4 but not E3.

Input neural layer 203 infers non-contextual embeddings. All subsequent neural layers 204-205 infer contextual embeddings.

### 2.1 Breadth-First Traversal from a Target Vertex

As discussed earlier herein, an intertwined neural network is configured to process only some breadth-first traversal subgraphs that may occur according to an express or implied schema of a graph. Each neural layer in intertwined neural dataflow 220 corresponds to one iteration of the breadth-first traversal from target cold vertex V1.

Intertwined neural dataflow 220 occurs in reverse order of the breadth-first traversal from target cold vertex V1. That is, the breadth-first traversal is apparent by demonstratively traversing intertwined neural dataflow 220 backwards (i.e. upwards). Thus, the breadth-first traversal reaches graph elements E3-E4 and V4 last but, counterintuitively, those graph elements E3-E4 and V4 are processed first (i.e. in reverse ordering from the search) in intertwined neural dataflow 220.

The breadth-first traversal is application specific, including radius and selectivity, both of which are reflected in intertwined neural dataflow 220 and in the configuration of the intertwined neural network. Selectivity is discussed later below. The radius of the breadth-first traversal is the length of the longest path from target cold vertex V1 in the breadth-first traversal, which is the same as a count of neural layers in the intertwined neural network. The breadth-first traversal visits a subgraph of graph 210. Herein the radius of the breadth-first traversal also is referred to as a radius of the subgraph. In the case of a path that contains a cycle as discussed below, the cyclic path extends by revisitation of vertex(s), in which case the actual radius of the subgraph is less than the radius of the breadth-first traversal.

Herein without a breadth-first traversal, the radius of a graph (or subgraph) is the longest acyclic path from target cold vertex V1, and the diameter of the graph is the longest acyclic path in the graph. In various examples, a count of neural layers in the intertwined neural network does or does not exceed one, some, or all of: three, a radius of the graph, and a diameter of the graph.

Selectivity means, as discussed earlier herein, the breadth-first traversal and the intertwined neural network may ignore some graph elements even though they occur within the traversal radius from target cold vertex V1.

### 2.2 Vertex Revisitation with or without Cyclicity

As shown, different red edges E1 and E4 are processed by different respective neural layers 203-204 despite having the same edge type. Herein, target cold vertex V1 is the root (i.e. source) of the breadth-first traversal. If a same graph element is reachable by multiple paths from target cold vertex V1 in a same iteration of the breadth-first traversal, then those multiple paths have identical lengths, in which case only one embedding is inferred for the graph element by the neural layer that corresponds to that iteration of the breadth-first traversal. For example, only one non-contextual embedding is inferred for hot vertex V4 even though hot vertex V4 is reachable by two edges E3-E4 in a same iteration that corresponds to input neural layer 203.

Although not shown, in a cyclic or acyclic graph, a same graph element may be reached by paths of different lengths in different iterations of the breadth-first traversal. In that case, a separate embedding is inferred for each iteration that processes the graph element. For example if red edges were undirected, then target cold vertex V1 could be revisited during the breadth-first search, and target cold vertex V1 could have a distinct respective embedding generated by each of neural layers 203 and 205. In that unshown case, a downstream application (e.g. anomaly detector) would receive the embedding inferred by output neural layer 205 but not the different embedding inferred by input neural layer 203. That is because the accuracy of distinct embeddings of a same graph element by distinct respective neural layers increases the further (i.e. deeper) is the neural layer from input neural layer 203. That is because contextual information increases with neural layer depth.

Selectivity is application specific. For example even though red edges E4 and E1 are respectively processed in two neural layers 203-204 in this example, a different intertwined neural network may instead be configured to process red edge E4 in an input neural layer but ignore red edge E1 in a hidden neural layer.

Although the radius and selectivity of the breadth-first traversal are predefined by the specific application, which graph elements are reached by the breadth-first traversal depends on which graph and which target vertex. For example, an intertwined neural network may be invoked twice, which is one invocation and one breadth-first traversal for each of two target vertices. Those two breadth-first traversals are schematically identical and have a same radius but, because they have different target vertices, different graph elements and different counts of graph elements may be processed by the different breadth-first traversals. For example, five graph elements may be processed for a first target vertex in a first invocation, and a thousand graph elements may be processed for a second target vertex in a second invocation of the same intertwined neural network for a same graph. For example, two (e.g. target or not) vertices of a same vertex type may have different counts of edges of a same edge type.

### 3.0 Learned Type-Specific Matrices Facilitate Embedding

FIG. 3 shows the internal operation of intertwined neural dataflow 220 that occurs in an intertwined neural network that contains learnable weights and learnable biases that are learned during training and are immutable after training for production inferencing.

As shown, input neural layer 203 infers non-contextual embeddings 301-303 that respectively represent graph elements V4 and E3-E4. Hidden neural layer 204 infers contextual embeddings 343-344 that respectively represent vertices V2-V3. Output neural layer 205 infers contextual embedding 340 that represent target cold vertex V1.

Generation of any of embeddings 301-303 and 340-344 entails mathematical use of three matrices. Each graph element type processed in each neural layer has a distinct set of three type-specific matrices as follows.

### 3.1 Matrix Sizing and Type Specific Learned Matrices

Each distinct set of three matrices includes a type-sized weight matrix, a type-specific bias vector, and a type-sized feature vector. Herein, a vector is a one-dimensional matrix. Herein, a type-sized matrix is a type-specific matrix whose size depends on the corresponding type of graph element. For example, the size (i.e. count of numeric array elements) of a feature vector of a red edge, shown as red features 323, may be different from the size of a feature vector of a blue edge, shown as blue features 322.

Herein, a type-specific matrix is a matrix whose numeric elements are learned for a specific graph element type. Herein even though each graph element type has its own bias vector, all bias vectors have a same size, regardless of graph element type, and that size is the same uniform size as all embeddings as discussed earlier herein. A weight matrix of a graph element type is a two-dimensional matrix having a horizontal dimension that is the same size as the uniform size of all embeddings and having a vertical dimension that is the same size as the feature vector of the graph element type.

### 3.2 Learned Matrices Specific to Neural Layer

The red edge type is processed by both of neural layers 203-204, and each of those two neural layers has a separate set of the three type-specific matrices used to process an edge of that type. For example, neural layers 203-204 respectively process red edges E4 and E1, which provide two distinct feature vectors because each graph element has its own feature vector. The two weight matrices (and the two bias vectors) for the red edge type contain different learned numeric values in the two neural layers 203-204. Because input neural layer 203 processes three graph element types (i.e. hot vertex type, blue edge type, and red edge type), input neural layer 203 has three weight matrices 311-313 and three bias vectors 331-333.

Weight matrices and bias vectors are immutable after training and depend on the graph element type, but do not depend on the graph itself. In other words, weight matrices and bias vectors are reusable for multiple graphs that conform to a same express or implied graph schema.

### 3.1 Matrix Arithmetic

Embedding inferencing mathematically operates as follows. Input neural layer 203 infers non-contextual embedding 301 that represents hot vertex V4 by multiplying the weight matrix of the hot vertex type, shown as learnable weights 311, times the feature vector of hot vertex V4, shown as hot features 321 to generate a product vector (not shown). The bias vector of the hot vertex type, shown as learnable bias 331, is arithmetically added to the product vector to calculate (i.e. generate) non-contextual embedding 301 that represents hot vertex V4.

Thus, any contextual or non-contextual embedding herein is generated by matrix multiplication followed by matrix addition in a similar way using type-specific matrices. Contextual embeddings 340-344 also are generated from similar type-specific matrices (not shown) that contain learned numbers.

Although all embeddings 301-303 and 340-344 are numeric arrays of a same uniform size (i.e. count of numeric elements) as discussed earlier herein, the allocation of the numeric elements differs as follows based on whether an embedding is contextual or non-contextual. In a non-contextual embedding, all of the numeric elements are used to store an encoding of all features of the graph element. For example, all embeddings may contain ninety numbers into which a hot vertex may have to encode twenty features, but a cold vertex may instead have to encode a hundred features into a same count of ninety numbers.

### 3.2 Novel Contextual Embedding Format

Each of contextual embeddings 340-344 is logically divided into three portions that each may contain a same or distinct count of numbers. For example as shown, contextual embedding 340 contains portions 300 and 351-352 that each contains multiple contiguous numeric array elements. The size (i.e. count of numeric elements) of each portion is application specific.

The feature vector (i.e. all cold vertex features) of cold vertex v1 is linearly encoded into cold features 300 in a way similar to the encoding of non-contextual embedding 301 discussed above, although the size of cold features 300 is less than the uniform size of each of embeddings 301-303 and 340-344.

Multiple edges E1 and E3 are connected to target cold vertex V1 in graph 210, and contextual embeddings 343-344 are aggregated into combined edge embeddings 352, even though edges E1 and E3 have different edge types. Depending on the embodiment, edge embeddings may be aggregated by numeric array element-wise averaging, element-wise summing, or whole embedding-wise concatenation.

Multiple vertices V2-V3 are connected to target cold vertex V1, and contextual embeddings 341-342 are aggregated into combined neighbors embeddings 351, even though vertices V2-V3 have different vertex types. Depending on the embodiment, vertex embeddings may be aggregated by numeric array element-wise averaging, element-wise summing, or whole embedding-wise concatenation.

All of contextual embeddings 340-344 have a same sized portion for combined neighbors embeddings. All of contextual embeddings 340-344 have a same sized portion for combined edges embeddings. All of contextual embeddings 340-344 have a same sized portion for encoding the feature vector of the respective graph element, even though different graph element types may have different counts and datatypes of features.

An embodiment may have three hyperparameters that indicate the respective (e.g. distinct) size of each of the three portions in all contextual embeddings 340-344. The three hyperparameters are application specific and/or graph schema specific, but they are not dependent on a graph element type and not dependent on which neural layer.

### 3.3 Using Multiple Aggregation Mechanisms

Although the size of the portion for combined neighbors embeddings is the same in all contextual embeddings 340-344, the aggregation mechanism may differ for different contextual embeddings. For example, two neural layers may each infer embedding(s) of a same edge type, but the aggregation of neighbor embeddings may use averaging in one of the two neural layers and, for the same edge type, the aggregation of neighbor embeddings may instead use concatenation in the other of the two neural layers. Thus, an aggregation mechanism may be any combination of: application specific, neural layer specific, and graph element type specific.

### 4.0 Example Intertwined Embedding Process

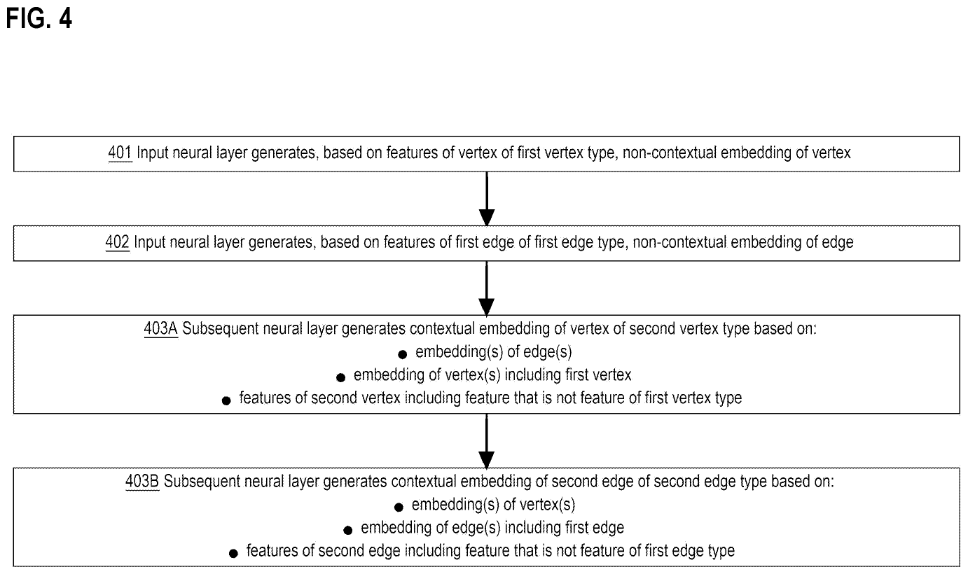

FIG. 4 is a flow diagram that depicts an example process that any computer herein may perform to infer embeddings of graph elements of graph 110 using an intertwined artificial neural network whose architecture reflects an express or implied schema of a graph. In this example, the process of FIG. 4 is invoked for target cold vertex V1. The process of FIG. 4 works for any graph of any schema, so long as the sequence of neural layers is accordingly specialized as discussed earlier herein. The process of FIG. 4 may occur in training or in production.

Steps 401-402 concurrently occur. Regardless of vertex type(s) and quantity(s), all non-contextual vertex embeddings inferred by input neural layer 203 are generated in step 401. Step 401 is performed by the vertex neural branch, such as discussed for vertex neural branch 101 earlier herein. In step 401, input neural layer 203 generates, based on all features of hot vertex V4, non-contextual embedding 301 that represents hot vertex V4 as discussed earlier herein.

Regardless of edge type(s) and quantity(s), all non-contextual edge embeddings inferred by input neural layer 203 are generated in step 402. Step 402 is performed by the edge neural branch, such as discussed for edge neural branch 102 earlier herein. In step 402, input neural layer 203 generates, based on all features of red edge E4, non-contextual embedding 303 that represents red edge E4 as discussed earlier herein.

Steps 403A-B concurrently occur with hidden neural layer 204 and then concurrently occur again with output neural layer 205, and these are referred to as subsequent neural layers 204-205. Step 403A occurs in the vertex neural branch, and step 403B concurrently occurs in the edge neural branch. In other words, both neural branches concurrently operate. However, multiple neural layers do not concurrently operate. A subsequent neural layer does not operate until the previous neural layer has already operated.

Regardless of vertex type(s) and quantity(s), all contextual vertex embeddings inferred by a current subsequent neural layer are generated in step 403A.

For example in step 403A, hidden neural layer 204 may generate contextual embedding 341 based on: non-contextual embeddings 301-303 and all features of hot vertex V2, as discussed earlier herein.

For example in step 403A, output neural layer 205 may generate contextual embedding 340 based on: contextual embeddings 341-344 and all features of cold vertex V1, as discussed earlier herein.

Step 403B is performed by the edge neural branch. Step 403B occurs with hidden neural layer 204. In this example, step 403B is not repeated with output neural layer 205 because output neural layer 205 does not infer an edge embedding. Regardless of edge type(s) and quantity(s), all contextual edge embeddings inferred by hidden neural layer 204 are generated in step 403B.

For example in step 403B, hidden neural layer 204 may generate contextual embedding 344 based on: non-contextual embeddings 301-303 and all features of red edge E1, as discussed earlier herein.

One, some, or all of the embeddings generated by the process of FIG. 4 may be accepted as input by a downstream analytic application such as an anomaly detector.

### 5.0 Demonstrative Pseudocode

In the following demonstrative pseudocode, the following terms are bold and have the following meanings.
aggr( ) in this example provides mask aggregation, which provides selectivity as discussed earlier herein.
sample_edges_by_type( ) provides edges connected to a given (e.g. target or non-target) vertex by random sampling without replacement. For example, a vertex may have ten red edges of which only three are sampled (i.e. randomly selected for inclusion in a breadth-first traversal as discussed earlier herein).
W_vertex_X( ) provides a learned weight matrix needed to generate an embedding of a given vertex type as discussed earlier herein.
b_vertex_X( ) provides a learned bias vector needed to generate an embedding of a given vertex type as discussed earlier herein.
layer_hop0_edge is all of the non-contextual edge embeddings generated by the edge neural branch in the input neural layer in step 402.
layer_hop0_vertex is all of the non-contextual vertex embeddings generated by the vertex neural branch in the input neural layer in step 401.
compute neighborhood combines neighbors embeddings and combines edge embeddings for a given vertex as discussed earlier herein per steps 403A-B.
layer_hop1_edge is all of the contextual edge embeddings generated by the edge neural branch in a hidden neural layer in step 403B.
layer_hop1_vertex is all of the contextual vertex embeddings generated by the vertex neural branch in a hidden neural layer in step 403A.
layer_hop2_vertex is all of the contextual vertex embeddings generated by the vertex neural branch in the output neural layer in step 403A.

```
// Notation
dst(edge, FORWARD) = dst(edge) // get the destination vertex of the edge
dst(edge, REVERSE) = src(edge) // get the source vertex of the edge
aggr( ) // mask aggregation
type( ) // gets vertex or edge type
sample_{—}edges_{—}by_{—}type(v) −> [
  [(edge1_type1,dir1), (edge2_type1,dir2), ...],
  [(edge1_type2,dir3), (edge2_type2,dir4), ...],
  ...
] //sample adjacent edges by type and their direction diven a vertex v
concat( ) //Concatenates the given tensors into one tensor
W_{—}vertex_{—}X(edge_type) // Fetches a matrix at layer X given the
edge_type
b_{—}vertex_{—}X(edge_type) // Fetches a bias at layer X given the edge_type
//Compute the embedding of edge2 at layer 0
layer_{—}hop0_{—}edge = (edge, dir) −> {
  return activation(
  W_self_edge_0(type(edge) * edge_features[type(edge)][edge] +
  b_self_edge_0(type(edge))
  );
}
//Compute the embedding of vertex at layer 0
layer_{—}hop0_{—}vertex (vertex) −> {
return activation (
  W_self_vertex_0(type(vertex)) *
  vertex_features[type(vertex)][vertex] +
  b_self_vertex_0(type(vertex))
  );
}
//Compute neighborhood of a vertex
compute_{—}neighborhood = (v1, layer=1) −> {
  sampled_edges_by_type = sample_edges_by_type(v3);
  aggregated_l0_edge_embeddings = aggr(
    [W_edge_1(edge_type) * aggr([layer_hop0_edge(edge0, dir0) for
    (edge0, dir0) in sampled_edges])
    + b_edge_1(edge_type) for sampled edges, edge_type in
    sampled_edges_by_type]
  );
  aggregated_l0_vertex_embeddings = aggr(
    [W_vertex_1(edge_type) * aggr([layer_hop0_vertex(v3) for v3 =
    dst(edge0, dir0) in sampled_edges]) + b_vertex_1(edge_type) for
    sampled_edges, edge_type in sampled_edges_by_type)]
  );
  return aggregated_l0_edge_embeddings,
  aggregated_l0_vertex_embeddings;
}
//Compute the embedding of edge2 at layer 1
layer_{—}hop1_{—}edge = (edge2, dir2) −> {
  v3 = dst(edge2, dir2);
  neigh_edges, neigh_vertices = compute_neighborhood(v3, layer1);
  self_emb = W_self_edge_1(type(edge2)) *
  edge_features[type(edge2)][edge2] + b_self_edge_1(type(edge2);
  return activation (concat (neigh_edges, neigh_vertices, self_emb));
}
//Compute the embedding of vertex v2 at layer 1
layer_{—}hop1_{—}vertex = (v2) −> {
  neigh_edges, neigh_vertices = compute_neighborhood(v2, layer1);
  self_emb = W_self_vertex_1(type(v2)) *
  vertex_features[type(v2)][v2] +
  b_self_vertex_1(type(v2)));
  return activation(concat(neigh_edges, neigh_vertices, self_emb));
}
//Compute the embedding of vertex v at layer 2
layer_{—}hop2_{—}vertex = (v) −> {
  sampled_edges_by_type = sample_edges_by_type(v);
  aggregated_l1_edge_embeddings = aggr(
[W_edge_2(edge_type) * aggr([layer_hop1_edge(edge0, dir0) for
(edge0, dir0) in sampled_edges])
+ b_edge_2(edge_type) for sampled_edges, edge_type in
sampled_edges_by_type]
  );
  aggregated_l1_vertex_embeddings = aggr(
    [W_vertex_2(edge_type) * aggr([layer_hop1_vertex(v3) for v3 =
    dst(edge0, dir0) in sampled_edges]) + b_vertex_2(edge_type) for
    sampled_edges, edge_type in sampled_edges_by_type]
  );
  self_emb = W_self_vertex_2(type(v)) *
  vertex_features[type(v)][v] +
  b_self_vertex_2(type(v));
  return activation(concat(aggregated_l1_edge_embeddings,
  aggregated_l1_vertex_embeddings, self_emb));
}
```

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

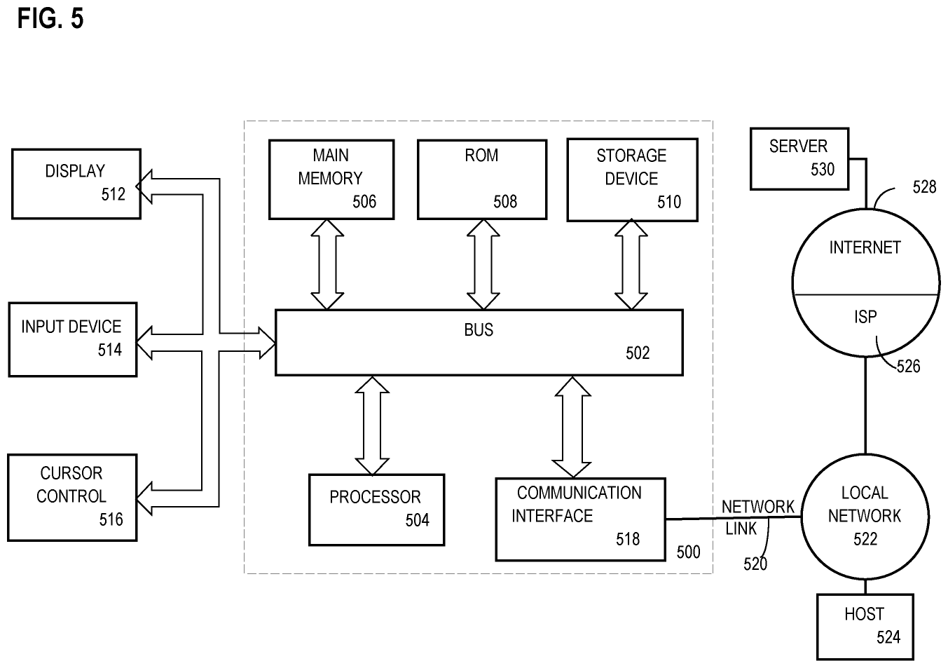

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

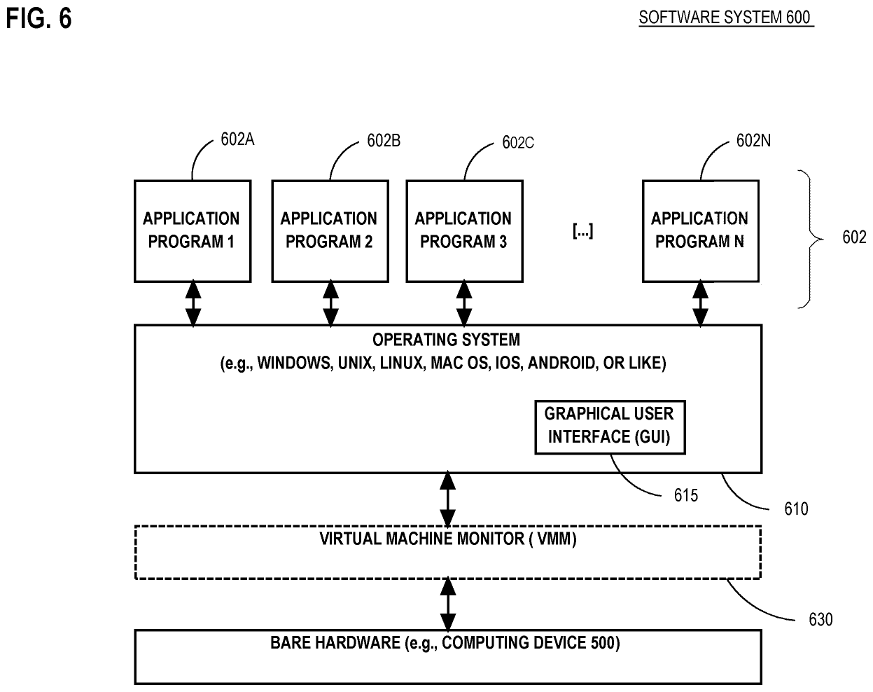

FIG. 6 is a block diagram of a basic software system 600 that may be employed for controlling the operation of computing system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computing system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device 1/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depends on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicated output. An error or variance between the predicated output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria is met.

In a software implementation, when a machine learning model is referred to as receiving an input, being executed, and/or generating an output or predication, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of best of breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neuron.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L-1 to a layer L. Given the number of neurons in layer L-1 and L is N[L-1] and N[L], respectively, the dimensions of matrix W is N[L-1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as vector. Training data comprises multiple inputs, each being referred to as sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Less neurons means less activation values need be computed, and/or less derivative values need be computed during training.

Properties of matrices used to implement a neural network correspond neurons and edges. A cell in a matrix W represents a particular edge from a neuron in layer L-1 to L. An activation neuron represents an activation function for the layer that includes the activation function. An activation neuron in layer L corresponds to a row of weights in a matrix W for the edges between layer L and L-1 and a column of weights in matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that is not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depends on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occurs as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas, unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
first generating, by an input neural layer of an artificial neural network, an embedding of a first vertex of a first vertex type in a graph, wherein:
the first generating is based on a plurality of features of the first vertex of the first vertex type, and
the embedding of the first vertex of the first vertex type has a predefined size that does not depend on the first vertex type;
second generating, by the input neural layer of the artificial neural network, an embedding of a first edge of a first edge type in the graph, wherein the second generating is based on a plurality of features of the first edge of the first edge type; and
third generating, by a subsequent neural layer of the artificial neural network, an embedding of a second vertex of a second vertex type, wherein the third generating is based on:
the embedding of the first vertex of the first vertex type and
a particular feature of the second vertex of the second vertex type that is not a feature of the first vertex of the first vertex type;
wherein the method is performed by one or more computers.

2. The method of claim 1 wherein the embedding of the second vertex of the second vertex type is based on an embedding of an edge.

3. The method of claim 1 further comprising fourth generating, by the subsequent neural layer of the artificial neural network, an embedding of a second edge of a second edge type, wherein:
the second edge of the second edge type connects the first vertex of the first vertex type to the second vertex of the second vertex type;
the fourth generating is based on:
the embedding of the first vertex of the first vertex type,
the embedding of the second vertex of the second vertex type, and
a particular feature of the second edge of the second edge type that is not a feature of the first edge of the first edge type.

4. The method of claim 1 wherein the artificial neural network is a multibranch neural network that comprises at least one selected from a group consisting of:
a neural branch that does not accept a feature vector that contains a feature of an edge and
a neural branch that does not accept a feature vector that contains a feature of a vertex.

5. The method of claim 1 wherein:
the input neural layer contains a respective first portion of each neural branch of two neural branches;
the subsequent neural layer contains a respective second portion of each neural branch of the two neural branches.

6. The method of claim 5 wherein:
the two neural branches consist of an input neural branch and a subsequent neural branch;
the input neural branch contains a first portion of the input neural layer and a first portion of the subsequent neural layer;
the subsequent neural branch contains a second portion of the input neural layer and a second portion of the subsequent neural layer.

7. The method of claim 6 further comprising performing at least one selected from a group consisting of:
a) acceptance, by the first portion of the subsequent neural layer in the input neural branch, output from the second portion of the input neural layer in the subsequent neural branch, and
b) acceptance, by the second portion of the subsequent neural layer in the subsequent neural branch, output from the first portion of the input neural layer in the input neural branch.

8. The method of claim 1 wherein:
the second generating is based on a subgraph of the graph;
a radius of the subgraph of the graph does not exceed a count of neural layers in the artificial neural network.

9. The method of claim 1 wherein a count of neural layers in the artificial neural network does not exceed at least one selected from a group consisting of: three, a radius of the graph, and a diameter of the graph.

10. The method of claim 1 wherein the particular feature is not imputed for the first vertex of the first vertex type.

11. One or more non-transitory computer-readable media storing instructions that, when executed by one or more processors, cause:
first generating, by an input neural layer of an artificial neural network, an embedding of a first vertex of a first vertex type in a graph, wherein:
the first generating is based on a plurality of features of the first vertex of the first vertex type, and
the embedding of the first vertex of the first vertex type has a predefined size that does not depend on the first vertex type;
second generating, by the input neural layer of the artificial neural network, an embedding of a first edge of a first edge type in the graph, wherein the second generating is based on a plurality of features of the first edge of the first edge type; and
third generating, by a subsequent neural layer of the artificial neural network, an embedding of a second vertex of a second vertex type, wherein the third generating is based on:
the embedding of the first vertex of the first vertex type and
a particular feature of the second vertex of the second vertex type that is not a feature of the first vertex of the first vertex type.

12. The one or more non-transitory computer-readable media of claim 11 wherein the embedding of the second vertex of the second vertex type is based on an embedding of an edge.

13. The one or more non-transitory computer-readable media of claim 11 wherein:
the instructions further cause fourth generating, by the subsequent neural layer of the artificial neural network, an embedding of a second edge of a second edge type;
the second edge of the second edge type connects the first vertex of the first vertex type to the second vertex of the second vertex type;
the fourth generating is based on:
the embedding of the first vertex of the first vertex type,
the embedding of the second vertex of the second vertex type, and
a particular feature of the second edge of the second edge type that is not a feature of the first edge of the first edge type.

14. The one or more non-transitory computer-readable media of claim 11 wherein the artificial neural network is a multibranch neural network that comprises at least one selected from a group consisting of:
a neural branch that does not accept a feature vector that contains a feature of an edge and
a neural branch that does not accept a feature vector that contains a feature of a vertex.

15. The one or more non-transitory computer-readable media of claim 11 wherein:
the input neural layer contains a respective first portion of each neural branch of two neural branches;
the subsequent neural layer contains a respective second portion of each neural branch of the two neural branches.

16. The one or more non-transitory computer-readable media of claim 15 wherein:
the two neural branches consist of an input neural branch and a subsequent neural branch;
the input neural branch contains a first portion of the input neural layer and a first portion of the subsequent neural layer;
the subsequent neural branch contains a second portion of the input neural layer and a second portion of the subsequent neural layer.

17. The one or more non-transitory computer-readable media of claim 16 wherein the instructions further cause performing at least one selected from a group consisting of:
a) acceptance, by the first portion of the subsequent neural layer in the input neural branch, output from the second portion of the input neural layer in the subsequent neural branch, and
b) acceptance, by the second portion of the subsequent neural layer in the subsequent neural branch, output from the first portion of the input neural layer in the input neural branch.

18. The one or more non-transitory computer-readable media of claim 11 wherein:
the second generating is based on a subgraph of the graph;
a radius of the subgraph of the graph does not exceed a count of neural layers in the artificial neural network.

19. The one or more non-transitory computer-readable media of claim 11 wherein a count of neural layers in the artificial neural network does not exceed at least one selected from a group consisting of: three, a radius of the graph, and a diameter of the graph.

20. The one or more non-transitory computer-readable media of claim 11 wherein the particular feature is not imputed for the first vertex of the first vertex type.
